(19) United States
(12) Patent Application Publication
(10) Pub. No.: US 2012/0223812 A1
(43) Pub. Date: Sep. 6, 2012

(54) Double wide forklift radio frequency

(75) Inventors: Kevin J. Kail, Great Falls, VA (US); Jason Kummerl, Warren, MI (US)

(73) Assignee: epcSolutions, Inc.

(21) Appl. No.: 13/385,718

(22) Filed: Mar. 5, 2012

Related U.S. Application Data
(60) Provisional application No. 61/457,345, filed on Mar. 4, 2011.

(51) Int. Cl. G06K 7/01

(52) U.S. Cl. 340/10.1

(57) ABSTRACT

A forklift RFID system on a double wide forklift for a stack of plastic pallets comprising: a double wide forklift comprising a body, a mast mounted to the body and at least two fork assemblies including forks moveably mounted on the mast. A RFID reader having a low power which does not read RFID tags outside of five feet is secured in a fixed position on the forklift body outside the forks of the forklift when the forks are in a closed position. A user interface assembly including a touch-panel display, with the reader being hardwired to the touch-panel display is mounted on the forklift body and software is utilized to provide information to the touch-panel display describing which RFID tags have been interrogated by the reader.

### RELATED APPLICATIONS

This is an application claiming priority and benefit from U.S. Provisional Patent Application No. 61/457,345 filed on Mar. 4, 2011.

### STATEMENT REGARDING FEDERALLY SPONSORED RESEARCH OR DEVELOPMENT

Not applicable.

### REFERENCE TO SEQUENCE LISTING, A TABLE OR A COMPUTER PROGRAM LISTING COMPACT DISC APPENDIX

None.

### BACKGROUND OF THE INVENTION

1. Field of Invention

The present invention relates to radio frequency identification (RFID) systems used with forklifts and more specifically, is directed to FRID systems used with a double wide forklift for tracking pallets stacked in columns ranging from 1 to 19 pallets in height.

2. Description of the Prior Art

Pallets are used worldwide to aid in the transport of products of various kinds, and are generally moved with the aid of a forklift truck or forklift. Because the pallets can be lifted, moved, and stored easily, they make the transportation of products simple and fast.

Conventional pallets are square or rectangular and include areas beneath which the forks of a forklift can enter to lift the pallet and are stored in stacks for later use. Typically pallets are constructed of wood and the individual pieces of the pallet are nailed, stapled, or otherwise fastened together. Currently, an improved plastic pallet has come on the market which is uniformly sized and provides greater resistance to the negative effects of moisture, such as mold or rotting and are easier to clean after use. These plastic pallets are provided with RFID tags in each corner, placed on or inside the pallet.

RFID tags are well-known and typically include an integrated circuit (IC) that is operatively coupled to a tag antenna. The RFID tags used in the pallets of the present invention preferably resonate in the UHF or microwave frequency band, either of which enables an RFID reader to interrogate and read the tags from a sufficiently long read range.

The IC associated with an RFID tag typically includes a certain amount of memory in which a tag identifier number is stored with optional other information related to the tag. Such other information can also include a GPS for locating, recording and verifying the position of each pallet when automated storage systems are used. When an RFID antenna transmits energy to interrogate the RFID tag, the tag responds with information from which an RFID reader can obtain the RFID tag identifier. The data obtained by the RFID reader is then compared to entries in a database of identifiers so that individual pallets in the pallet stack are identified and recorded. In that manner, information regarding each specific pallet may be obtained, updated, and provided to a user for transportation, billing, storage or inventory.

Many companies own pallets, however, for large pallet usage third party owners of pallets lease them to other companies for their use. Following the use of a pallet in one destination, the pallets might be returned to the user entity, another entity, or to a specific location for reuse, reconditioning, repair, or disposal. For pallets with RFID tags, up-to-date information including information concerning the pallet is electronically entered in a database and the tag is associated with information about the current status and the history of the pallet. Thus, tagging the pallet can help record the location of the pallet, the condition of the pallet, the time the pallet spends at any particular pallet handler, the destination and routing schedule, and history of the pallet including pallet repairs, and other information of interest to the user or owner, or both. This and other information can be obtained quickly and easily from each pallet by simply using an RFID reader to interrogate the RFID tags associated with the pallet. This information is obtained from an RFID reader on a forklift truck, allowing the RFID tags associated with each pallet in a stack of pallets to be interrogated, and the location of a particular pallet can be tracked within a warehouse, distribution center, or other facility.

Forklifts pose a challenging environment for RFID to work effectively and double wide forklifts present additional problems. The typical double wide forklift has asymmetric environment differences between the right fork assembly and the left fork assembly with the right support cross bar being 21 inches in height from the fork tine and the left support bar being 26 inches in height from the fork tine. Radio frequency waves are absorbed significantly higher on the left side versus the right side due to the positioning and density of the metal fork. Additional RFID reading issues are encountered when the operator widens the forks of the fork lift. When high powered RF readers are used, stray RFID tags within the warehouse are read and included as being loaded in the forklift pallet stack. There is also the problem that there is restricted space on the forklift to mount the reader due to the hydraulic moving parts of the forklift. The bulk of the forklift body, mast and fork assemblies is made of metal which interferes with the RF communication and forklifts are driven a fast speeds and are constantly bumping into objects so all mounted parts, namely the antenna and reader(s) on the forklift must be secured and protected from contact. In addition large numbers of hoses, cables and pulleys are required to operate the forklift which need to be unobstructed for the forklift to move and be accessible for maintenance. Most antennae cables are standard coaxial cables which have limited flexibility that makes them difficult to thread. Furthermore, the carriage and forks move and slide in multiple ways which restrict the areas for placing antennas and readers and interfere with RFID readouts.

Various patents and publications have described the use of RFID tags with pallets. For example, Netherlands Publication Document 9401836 describes a process and system for the identification of pallets, in which an RFID tag (transponder) is installed in the center of the pallet. U.S. Pat. No. 7,342,496 and U.S. Patent Publication Number 2005/0076816 discloses pallets which have RFID tags mounted thereon. Antennae elements are provided in the forks of a pallet moving apparatus, which is supposed to enable a device to obtain information from the RFID tag. U.S. Pat. Nos. 5,662,048 and 5,971,592 also relate to a pallet having a data storage device from which a data collection device can obtain information.

U.S. Pat. No. 6,669,089 is directed to a forklift with two spaced RFID antennas positioned in a column on either side of the forks of the forklift.

Unfortunately, the above patents and publications do not solve the problem of accurately identifying individual pallets within stacks of pallets as these systems pick up stray RFID tag readings within the warehouse leading to erroneous readings. Furthermore, when pallets are read by forklifts, issues are encountered upon widening the forks of the forklift, as RF waves are absorbed by the forklift metal with the result that the targeted pallets reading results are inconsistent.

The problem that typically occurs with a reader on the side of the forklift or on readers placed horizontally apart is that the multiple tag readings of stacks of pallets are lost or misidentified so that tracking and inventory have unacceptable loss percentages.

These teachings do not aid in the resolution of a number of practical difficulties that are resolved by the present invention.

It has been found that lower powered RF readers yield reads of only the targeted pallets located less than five horizontal feet from the reader.

### SUMMARY OF THE INVENTION

The present invention provides a double wide forklift tracking system for tracking stacks of pallets up to a height of 30 pallets and more preferably, stacks of pallets ranging from 1 to 19 pallets in height. The inventive double wide forklift pallet tracking system utilizes: a) at least one RFID reader mounted to and positioned to the side of the double wide forklift; b) the RFID reader being of a low power and having a limited effective range which reads up to five feet; and c) a plurality of plastic pallets, each individual plastic pallet including identical RFID tags in each corner to enable said RFID tags to be interrogated by an RFID reader antenna and specifically identified.

It is an object of the invention to provide a double wide forklift reading system which does not require precise operator alignment of the forks to obtain accurate pallet readings.

Another object of the present invention provides a specifically configured forklift having a mast and a load backrest with an RFID antenna positioned on each side of the double wide forklift.

It is still another object of the invention is use of a low power RFID reader having a limited horizontal range of about five feet.

It is yet another object of the invention to provide plastic pallets having all four corners tagged with RFID tags, each individual plastic pallet being provided with multiple, identical RFID tags.

These and other objects, advantages, and novel features of the present invention will become apparent when considered with the teachings contained in the detailed disclosure along with the accompanying drawings.

### BRIEF DESCRIPTION OF THE DRAWINGS

The present invention will be described with reference to the appended Figures, in which:

FIG. 1 illustrates a front perspective view of a double wide forklift with the forks expanded having the RFID reader antenna spaced outside the body of the forklift;

FIG. 2 is a rear perspective view of a double wide forklift of FIG. 1;

FIG. 3 is a side perspective view of the double wide forklift with the forks in a closed mode;

FIG. 4 is an enlarged rear view of the an RFID antenna mounted to the forklift;

FIG. 5 is a partial front perspective view of the RFID antenna shown in FIG. 1; and

FIG. 6 is a perspective view of a stack of pallets having imbedded RFID tags.

### DESCRIPTION OF THE INVENTION

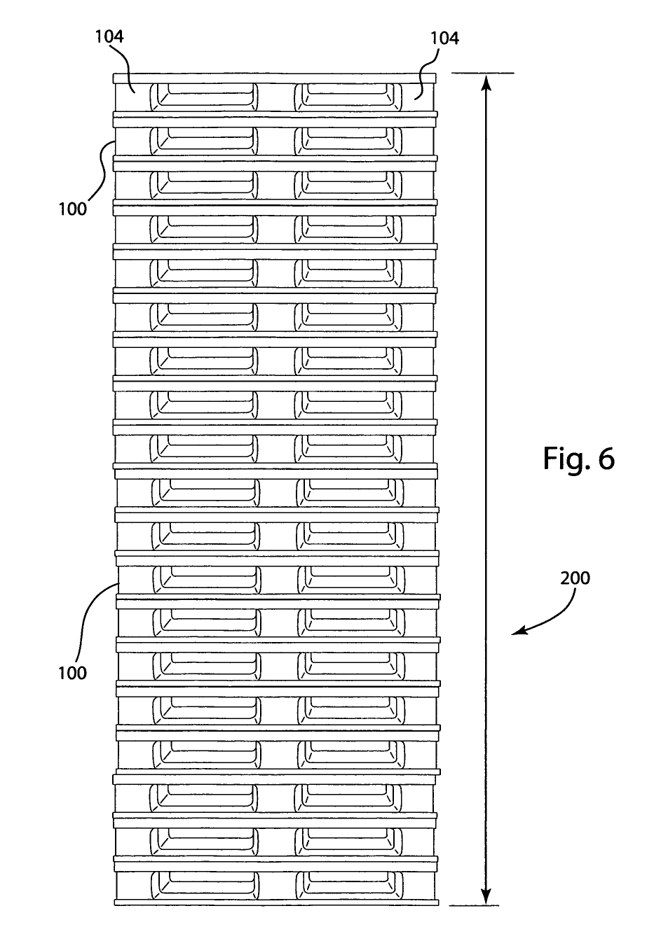

The present invention is directed toward identifying pallets themselves as opposed to pallets holding goods. The use of pallets is prevalent in modern day industry and large numbers of pallets are shipped and moved throughout storage facilities. The pallets come in standard sizes and define fork apertures which can receive the tines of a standard forklift. Thus, there exists a need to account for and correctly inventory the individual pallets in a stack of pallets as the same are moved, stored or shipped. Accordingly, the present invention uses a double wide forklift which reads and identifies a stack of pallets, and each individual pallet in the stack. While the pallet can be provided with several RFID tags, it is preferred that each pallet has multiple, identical RFID tag(s) with a single RFID tag located in each corner of the pallet. As a result of the RFID tag placement, the information regarding the pallet is more easily and reliably obtained when the RFID reader interrogates the RFID tag(s). The invention is directed toward identifying individual pallets carried in multiple in pallet stacks and is specifically directed toward identifying individual pallets in multiple pallets stacks carried by a double width forklift ranging from 1 to 19 pallets in height and is most preferably directed toward pallet stacks which are 19 individual pallets in height. An exemplary single pallet stack of 19 individual pallets is shown in FIG. 6.

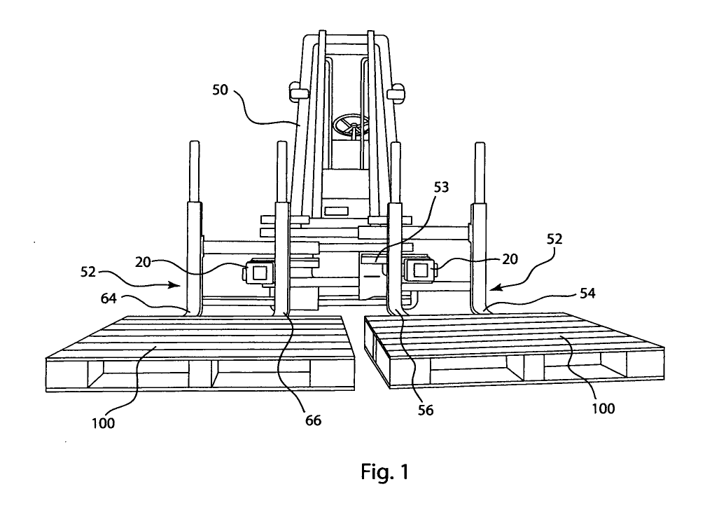

As shown in FIG. 1, an antenna reader 20 is mounted to the side of the forklift 50 to successfully interrogate RFID tags (not shown) mounted to pallets 100 placed in a stack of pallets 200 as shown in FIG. 6.

An antenna/reader array is necessary to enable the RFID forklift system to interrogate all those pallets substantially simultaneously. Readers such as Alien 9900, Motorola RD5000, Motorola XR450 and Things Magic Mercury4e have also been used with the invention but these readers have been modified from the manufacturer shelf models to operate at a lower power so that the readers have an effective horizontal range of up to five feet, preferably 3 to 5 feet. The preferred terminal used in the system is the LXE Touch Screen. All of the above components in the system are standard over the counter instrumentation which are readily available. It is acknowledged that other equivalent antenna, readers and screens could be used with the invention.

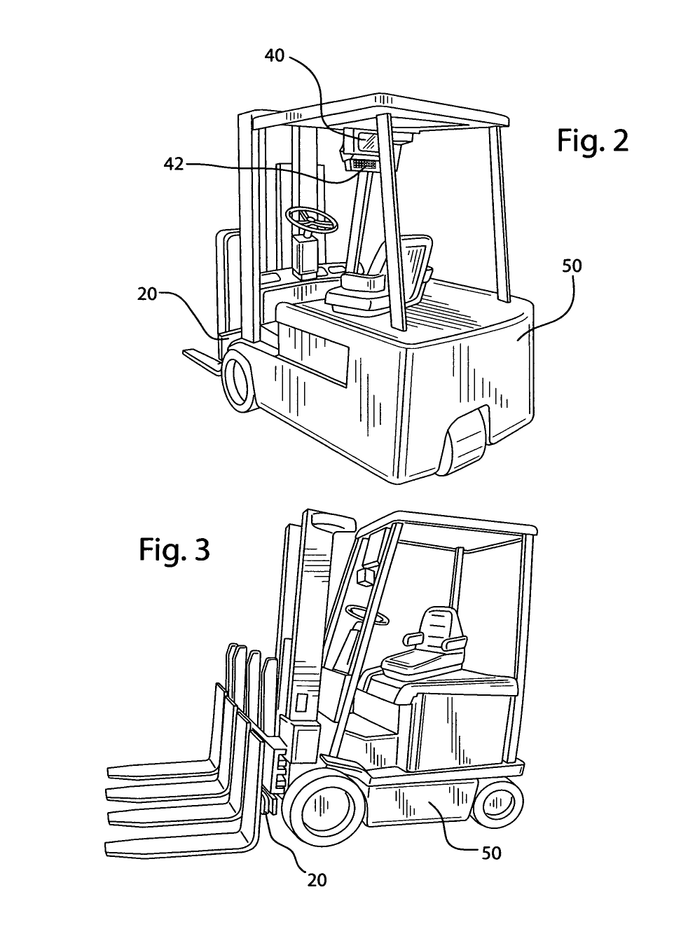

The preferred mounting and orientation for the antenna and reader in the RFID system is to mount the same to the forklift body outside of the forks of the forklift. The antenna 20 is preferably mounted on the carriage 53 outside of the left forks 54/56 and right forks 64/66 of the double wide forklift prior to extension and left fork 56 and right fork 66 after extension. The RFID reader is of a low power and can only effectively read pallet at a distance up to five horizontal feet. A touch panel 40 is connected to reader 20 and hardwired by a cable (not shown). The touch panel 40, as shown in FIG. 2, is connected to an inboard or remote computer and data base to allow entering and retrieval of the pallet information. The touch screen allows the operator to enter the data for a stack of pallets into the database once the pallets within a stack of pallets have been identified.

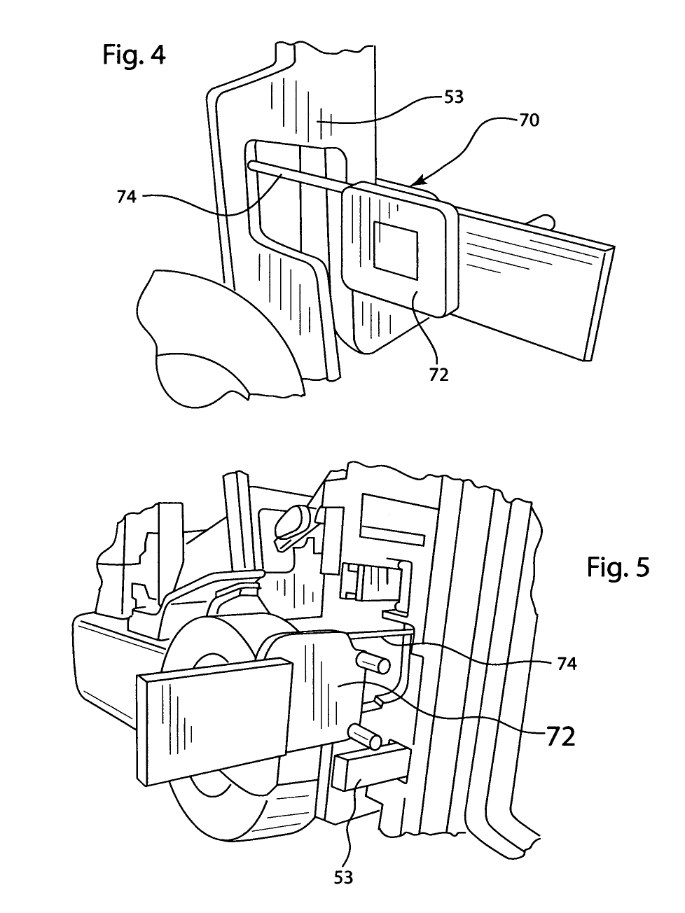

The present invention provides readers 20 on double wide forklifts 50 in a specific positioned particular manner to obtain maximum individual RFID tagged pallet reading efficiency. As shown in FIG. 1, a reader antenna array 20 comprises one or more reader antennae 20 positioned in a fixed position on a carriage or back frame 53 of a forklift 50 behind the fork assemblies 52, the left fork assembly having forks or tines 54/56 and the right fork assembly having forks or tines 64/66. The reader antenna array 20 is positioned outside the outer fork tines (54, 64) when the same are in a closed position as is seen in FIGS. 4 and 5 and inside the outer fork tines (54, 64) when the same are in an open condition as seen in FIG. 1. The reader holder, as shown in FIG. 4, is in the nature of a sleeve or bracket assembly 70 having a sleeve member 72 on which the reader is mounted and a support rod 74 secured to the sleeve member 72.

In the preferred embodiment of the invention shown in FIG. 1, a forklift 50 is equipped with a RFID reader 20 on each side outside the inner fork 56/66 of the respective fork assembly when the same are opened. If desired a single RFID reader can be utilized on only one side of the forklift. The RFID reader is connected to a display screen 40 as seen in FIG. 2 by a cable or by wireless means well known in the art. The reader 20 is low powered with an antenna having a range of up to five feet, preferably about 3 to 5 feet. The back frame to which the carriage is mounted is connected to a hydraulic lift system associated with mast that lifts the back frame and the carriage and forks, to elevate the pallet load. The lift system is also able to shift the frame and forks from side-to-side, and the forks themselves are typically hydraulically laterally adjustable to enable them to fit under or within pallets of different dimensions. It should be noted that double wide forklifts have a vertical cross bar of a different height on each fork assembly. The tag information read by the reader is fed to a computer which can alternatively use filter software which compares tag identification for specific pallets which are being continuously read by the reader and eliminates those tags which do not show a substantially continuous read.

One particular advantage of an antenna arrangement of this type, where the reader/antenna(e) are provided on the fixed portion of the forklift and are positioned to the side of the fork assemblies is that essentially all of the pallets of a stack of empty RFID-tagged pallets can be interrogated almost simultaneously by the one reader/antenna.

The positioning of the readers 20 shown in FIG. 1 provides several advantages. First, antenna is positioned so as not to obscure the forward view of the forklift operator so that operating ability of the driver is not impaired and secondly, the metal components of the forks do not interfere with the RFID reading.

Cable or cables are used to connect the various components of the present invention (including the RFID reader, the RFID antennae, a power source, a touch-panel display 40 or other user interface) and should be sufficiently durable and protected to avoid damage in the conditions to which the forklift is expected to be exposed. Forklifts are notorious for inflicting and sustaining damage, and the components and connections should, to the extent possible, be covered or otherwise protected. To the extent that cables connect components on the fixed portion of the forklift to ones on the movable part, those cables can be festooned through pulleys or other suitable structures to maintain their position and appropriate tension.

The system of the present invention as previously noted preferably also includes a user interface, such as a display 40 (which may be a touch-panel display) visible to an operator of the forklift, a keyboard 42, and a removable data storage device (such as a floppy disc drive, or flash memory card). The user interface preferably is adapted to display information to the operator regarding the pallets interrogated by the RFID reader antenna, the pallets (which information may be available from the RFID tags, a database, or a combination of the two), how many RFID tags were successfully interrogated, which location tag(s) are the closest, which location tags maintain a constant sensing and other information of the type described earlier. Reading and transmission of data is accompanied by software developed by the assignee of this invention. The user interface enables the operator to input additional data (for example through the touch-panel display or keyboard), such as the condition of the pallet or its contents, the time that it was picked up or dropped off, the operator's identity, or other such information. The touch-screen display may also include a calibration system, so that no keyboard is required when a screen is repaired or replaced.

Each pallet 100 is preferably provided with four identical RFID tags inside the pallet, one in each corner area of the pallet, the general location of which is shown at 104. Since the pallets are plastic, the tags 104 are buried in each corner of the pallet in an internal tube shaped support. Each pallet 100 is preferably provided with RFID tags which have identical information allowing each pallet to be read regardless of the direction or angle of the antenna exciter.

The advantages of the present invention are numerous and substantial. Among them are the ability to successfully interrogate multiple pallets, and the ability to approach and interrogate multiple pallets or multiple pallet loads from any one of four directions. Although the present invention has been described primarily with reference to pallets, persons of skill in the art will understand that these teachings can also be applied to containers, bins, racks, totes, or other storage devices.

The principles, preferred embodiments and modes of operation of the present invention have been described in the foregoing specification. However, the invention should not be construed as limited to the particular embodiments which have been described above. Instead, the embodiments described here should be regarded as illustrative rather than restrictive. Variations and changes may be made by others without departing from the scope of the present invention as defined by the following claims:

What we claim is:

1. A forklift RFID system for identifying RFID tagged pallets in multiple stacks of pallets comprising:
a) a double wide forklift comprising a body, a mast mounted to said body and right and left fork assemblies moveably mounted on said mast, each assembly comprising a plurality of moveable forks;
b) at least one RFID reader is secured in a fixed position to forklift body outside of the forks of said fork assemblies when the same are in a closed position; and
c) each said RFID reader being low powered to read RFID pallet tags located at a horizontal distance ranging up to about 5 feet from said RFID reader.

2. The forklift RFID system of claim 1 wherein said pallets each have an RFID tag located in each corner, each RFID tag providing identical readings.

3. The system RFID system of claim 1 wherein said pallet stack ranges from 2 to 30 pallets in height.

4. The forklift RFID system of claim 1 wherein said pallet stack is 19 pallets in height.

5. The forklift RFID system of claim 1 wherein said pallet tag reading range is about 3 feet to about 5 feet.

6. The forklift RFID system of claim 1 wherein the system further comprises software adapted to provide information to a user interface identifying all of the pallets in a single pallet stack.

7. The forklift RFID system of claim 1 wherein a RFID reader is positioned on each side of said forklift body.

8. The forklift RFID system of claim 1 wherein said RFID reader is hardwired to a touch-panel display.

9. The forklift RFID system of claim 8 wherein said touch-panel display has an associated keyboard.

10. The forklift RFD system of claim 8 wherein said touch-panel display has a removable data storage device.

11. A forklift RFID system for identifying RFD tagged pallets in a stack of pallets comprising:
a) a double wide forklift comprising a body, a mast mounted to said body and right and left fork assemblies moveably mounted on said mast; each forklift assembly being with two parallel extending tines;
b) two RFID readers are secured in a fixed position on opposite sides of said forklift body above the tines of the forklift assembly;
c) each RFID reader being positioned outside said forklift body and
d) each said RFID reader having reduced power to read RFID tags at a horizontal distance of not greater than about 5 feet.

12. The forklift RFID system of claim 11 wherein said pallets each have an RFID tag located in each corner.

13. The system RFID system of claim 11 wherein said pallet stack ranges from 10 to 19 pallets in height.

14. The forklift RFID system of claim 11 wherein said pallet stack is 19 pallets in height.

15. The forklift RFID system of claim 12 wherein all of said pallet tags in an individual pallet have the same RFID identification reading.

16. The forklift RFID system of claim 11 wherein the system further comprises software adapted to provide information to a user interface regarding a pallet.

17. A forklift RFID system for identifying RFID tagged plastic pallets tagged in each corner with identical RFID tags in a stack of pallets comprising:
a) a double wide forklift comprising a body, a mast mounted to said body and right and left fork assemblies moveably mounted on said mast; each fork assembly including a plurality of extending moveable tines;
b) RFID readers with an internal antenna mounted on said forklift body in a fixed position above the forks of the forklift on each side of said forklift body;
d) each RFID reader being powered to transmit RFID and accurately read RFID tags of plastic pallets at a horizontal distance not exceeding about 5 feet.

18. A method of reading and identifying stacked RFID tagged pallets tagged in corners of said pallet using a double width forklift comprising the steps of
a) generating a low powered RFID signal from a reader/antenna having an effective horizontal range which does not exceed about five feet; from at least one side of a double width forklift;
b) reading the individual signals from received from each pallet in a pallet stack and transmitting the individual signals to a computer;
c) identifying the signals with a corresponding pallet; and
d) recording each pallet in a database.

19. A method of reading and identifying stacked RFID tagged pallets as claimed in claim 18 wherein at least one tag is provided with a GPS and including the additional step of:
e) locating the position of each pallet and identifying the position in a pallet storage area.

20. A method of reading and identifying stacked RFID tagged pallets as claimed in claim 18 wherein said horizontal range is about 3 feet and to about 5 feet and each pallet is plastic.
